(19) United States
(12) Patent Application Publication
(10) Pub. No.: US 2010/0053111 A1
(43) Pub. Date: Mar. 4, 2010

(54) MULTI-TOUCH CONTROL FOR TOUCH SENSITIVE DISPLAY

(75) Inventor: Soren KARLSSON, Upplands Vasby (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/204,324

(22) Filed: Sep. 4, 2008

(51) Int. Cl. G06F 3/045

(52) U.S. Cl. 345/174

(57) ABSTRACT

A method performed by a device having a touch panel and a display includes identifying touch coordinates of a first touch on the touch panel, and associating the first touch coordinates with an object on the display. The method also includes identifying touch coordinates of a second touch on the touch panel, and associating the second touch coordinates with an object on the display. The method also includes associating the second touch with a command signal based on the coordinates of the first touch and the second touch; and altering the display based on the command signal.

### BACKGROUND

Many handheld devices include some kind of display to provide a user with visual information. These devices may also include an input device, such as a keypad, touch screen, and/or one or more buttons to allow a user to enter some form of input. A growing variety of applications and capabilities for handheld devices continues to drive a need for improved user input techniques.

### SUMMARY

In one implementation, a method performed by a device having a touch panel and a display may include identifying touch coordinates of a first touch on the touch panel, associating the first touch coordinates with an object on the display, identifying touch coordinates of a second touch on the touch panel, associating the second touch coordinates with an object on the display, associating the second touch with a command signal based on the coordinates of the first touch and the second touch, and altering the display based on the command signal.

Additionally, the first touch may be maintained during the second touch.

Additionally, the first touch may be removed prior to the second touch; and the method may further include determining a time interval between the first touch and the second touch and comparing the time interval with a stored value that indicates the first touch is associated with the second touch.

Additionally, the object may be an image; and the command action may include altering the magnification of the image on the display using the touch coordinates of the first touch as the centering point for the altering of the magnification.

Additionally, the object may be a text sequence; and the command action may include altering the magnification of a portion of the text sequence on the display using the touch coordinates of the second touch to identify the portion of the text where the altering of the magnification is implemented.

Additionally, the second touch may be dragged along the touch panel, and altering the magnification of a portion of the text sequence may include altering the magnification of the portion of the text above the changing coordinates of the dragged second touch.

Additionally, the object may be a file list; and the command action may include copying a file selected with the second touch to a file list selected with the first touch.

In another implementation, a device may include a display to display information, a touch panel to identify coordinates of a first touch and coordinates of a second touch on the touch panel, processing logic to associate the first touch coordinates with a portion of the information on the display, processing logic to associate the second touch coordinates with another portion of the information on the display, processing logic to associate the second touch with a command signal based on the portion of the information on the display associated with the first touch coordinates and the other portion of the information on the display associated with the second touch coordinates, and processing logic to alter the display based on the command signal.

Additionally, the touch panel may include a capacitive touch panel.

Additionally, the processing logic may alter the magnification of the information on the display using the touch coordinates of the first touch as the centering point for the altering of the magnification.

Additionally, the processing logic may alter the magnification of a portion of the information on the display based on the touch coordinates of the second touch that identify the portion of the information where the altering of the magnification is to be implemented

Additionally, the information on the display may be text and altering the magnification may include changing the font size of the text.

Additionally, the information on the display in the vicinity of the second touch coordinates may be presented in a magnifying window.

Additionally, the portion of information associated with the first touch coordinates may be a file list, the portion of information associated with the second touch coordinates may be a file selected by a user, and the command signal may include a signal to copy the file selected by the user to the file list.

Additionally, the touch panel may be overlaid on the display.

Additionally, the touch panel may further include a housing, where the touch panel and the display may be located on separate portions of the housing.

Additionally, a memory to store a list of touch sequences that may be interpreted differently for particular applications being run on the device, where the processing logic to associate the second touch with a command signal may be further based on the list of touch sequences.

In another implementation, a device may include means for means for identifying touch coordinates of a first touch and a second touch on a touch panel, where the first touch precedes the second touch and the first touch is maintained during the second touch, means for associating the first touch coordinates with information on the display, means for associating the second touch coordinates with information on the display, means for associating the second touch with a command signal based on the information associated with the first touch and the second touch, and means for altering the display based on the command signal.

Additionally, the means for altering the display based on the command signal may include means for altering the magnification of information on the display using the touch coordinates of the first touch as the centering point for the altering of the magnification.

Additionally, the means for altering the display based on the command signal may include means for altering the magnification of a portion of information on the display using the touch coordinates of the second touch to identify the portion where the altering of the magnification is implemented.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIG. 1 is a schematic illustrating an exemplary implementation of the systems and methods described herein;

FIG. 2 is a diagram of an exemplary electronic device in which methods and systems described herein may be implemented;

FIG. 3 is a block diagram illustrating components of the electronic device of FIG. 2 according to an exemplary implementation;

FIG. 4 is functional block diagram of the electronic device of FIG. 3;

FIGS. 5A and 5B are diagrams illustrating exemplary touch sequence patterns on the surface of an exemplary electronic device;

FIG. 6 is a flow diagram illustrating exemplary operations associated with the exemplary electronic device of FIG. 2;

FIG. 7 shows an exemplary touch input on the surface of a display as a function of time according to an exemplary implementation;

FIG. 8 shows an exemplary touch input on the surface of a display as a function of time according to another exemplary implementation;

FIG. 9A shows an exemplary touch input on the surface of a display as a function of time according to a further exemplary implementation;

FIG. 9B shows an alternate implementation of the exemplary touch input of FIG. 9A; and

FIG. 10 is a diagram of another exemplary electronic device in which methods and systems described herein may be implemented.

### DETAILED DESCRIPTION

The following detailed description refers to the accompanying drawings. The same reference numbers in different drawings may identify the same or similar elements. Also, the following detailed description does not limit the invention.

### Overview

Touch panels may be used in many electronic devices, such as cellular telephones, personal digital assistants (PDAs), smartphones, portable gaming devices, media player devices, camera devices, etc. In some applications, a transparent touch panel may be overlaid on a display to form a touch screen.

The term “touch,” as used herein, may refer to a touch of an object, such as a body part (e.g., a finger) or a pointing device (e.g., a soft stylus, pen, etc.). A touch may be deemed to have occurred if a sensor detects a touch, by virtue of the proximity of the deformable object to the sensor, even if physical contact has not occurred. The term “touch panel,” as used herein, may refer not only to a touch-sensitive panel, but a panel that may signal a touch when the finger or the object is close to the screen (e.g., a capacitive screen, a near field screen).

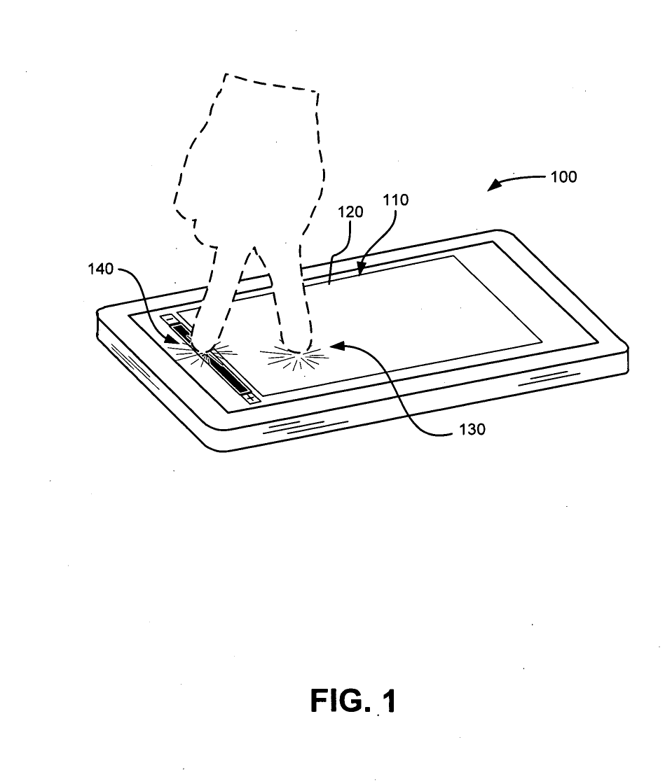

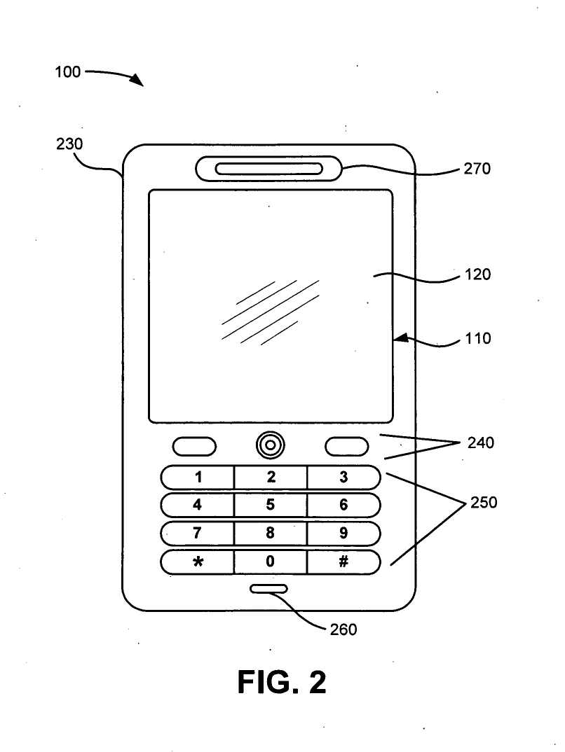

FIG. 1 is a schematic illustrating an exemplary implementation of the systems and methods described herein. Implementations described herein may utilize touch-recognition techniques that distinguish between a first touch input and a second touch input. The first touch input may identify an object or location on a display, while the second touch input may provide a command action associated with the object or location identified by the first touch. Referring to FIG. 1, an electronic device 100 may include a display 110 and a touch panel 120 overlaying display 110. More details of electronic device 100 are provided with respect to FIGS. 2-4.

FIG. 1 illustrates a dual touch input applied to electronic device 100. A first touch 130 may be applied at a first location on touch panel 120. At a time after the first touch, a second touch 140 may be applied at a second location on touch panel 120. The location of the first touch 130 may be associated with an image on display 110. For example, touch 130 may be placed over a portion of an image of which a user desires an enlarged view. Second touch 140 may be located at a different location on touch panel 120 than first touch 130. Second touch 140 may be processed by electronic device 100 as a command input related to the first touch.

In one implementation, the time interval between the first touch 130 and the second touch 140 and/or the location of the second touch 140 may be used to indicate to electronic device 100 that the second touch 140 is a command input associated with the initial touch 130. In one implementation, second touch 140 may be interpreted as command to alter the magnification of an image using the first touch 130 as a centering point. In another implementation, second touch 140 may be interpreted as command to transfer a file or other information from one folder location to another. In a further implementation, second touch 140 may be interpreted as command to alter the magnification of a portion of an image or a particular section of a block of text on display 110.

### Exemplary Device

FIG. 2 is a diagram of an exemplary electronic device 100 in which methods and systems described herein may be implemented. Implementations are described herein in the context of an electronic device having a touch panel. As used herein, the term “electronic device” may include a cellular radiotelephone; a smart phone, a Personal Communications System (PCS) terminal that may combine a cellular radiotelephone with data processing, facsimile and data communications capabilities; a personal digital assistant (PDA) that can include a radiotelephone, pager, Internet/Intranet access, Web browser, organizer, calendar and/or a global positioning system (GPS) receiver; a gaming device; a media player device; a digital camera; or another device that may use touch panel input. While implementations herein may be described in the context of a handheld electronic device having a touch screen (e.g., a touch panel overlaid on a display), other implementations may include other touch-panel-enabled devices, such as a desktop, laptop or palmtop computer.

Referring to FIG. 2, electronic device 100 may include display 110, touch panel 120, housing 230, control buttons 240, keypad 250, microphone 260, and speaker 270. The components described below with respect to electronic device 100 are not limited to those described herein. Other components, such as a camera, connectivity ports, memory slots, and/or additional speakers, may be located on electronic device 100.

Display 110 may include a device that can display signals generated by electronic device 100 as text or images on a screen (e.g., a liquid crystal display (LCD), cathode ray tube (CRT) display, organic light-emitting diode (OLED) display, surface-conduction eletro-emitter display (SED), plasma display, field emission display (FED), bistable display, etc.). In certain implementations, display 110 may provide a high-resolution, active-matrix presentation suitable for the wide variety of applications and features associated with typical mobile devices.

Display 110 may provide visual information to the user and serve—in conjunction with touch panel 120—as a user interface to detect user input. For example, display 110 may provide information and menu controls regarding incoming or outgoing telephone calls and/or incoming or outgoing electronic mail (e-mail), instant messages, short message service (SMS) messages, etc. Display 110 may further display information and controls regarding various applications executed by electronic device 100, such as a web browser, a phone book/contact list program, a calendar, an organizer application, image manipulation applications, navigation/mapping applications, an MP3 player, as well as other applications. For example, display 110 may present information and images associated with application menus that can be selected using multiple types of input commands. Display 110 may also display images associated with a camera, including pictures or videos taken by the camera and/or received by electronic device 100. Display 110 may also display video games being played by a user, downloaded content (e.g., news, images, or other information), etc.

As shown in FIG. 2, touch panel 120 may be integrated with and/or overlaid on display 110 to form a touch screen or a panel-enabled display that may function as a user input interface. For example, in one implementation, touch panel 120 may include near field-sensitive (e.g., capacitive) technology, acoustically-sensitive (e.g., surface acoustic wave) technology, photo-sensitive (e.g., infra-red) technology, pressure-sensitive (e.g., resistive) technology, force-detection technology and/or any other type of touch panel overlay that allows display 110 to be used as an input device.

Generally, touch panel 120 may include any kind of technology that provides the ability to identify multiple touches and/or a sequence of touches that are registered on the surface of touch panel 120. Touch panel 120 may also include the ability to identify movement of a body part or a pointing device as it moves on or near the surface of touch panel 120.

In one embodiment, touch panel 120 may include a capacitive touch overlay including multiple touch sensing points capable of sensing a first touch followed by a second touch. An object having capacitance (e.g., a user's finger) may be placed on or near touch panel 120 to form a capacitance between the object and one or more of the touch sensing points. The amount and location of touch sensing points may be used to determine touch coordinates (e.g., location) of the touch. The touch coordinates may be associated with a portion of display 110 having corresponding coordinates. A second touch may be similarly registered while the first touch remains in place or after the first touch is removed.

In another embodiment, touch panel 120 may include projection scanning technology, such as infra-red touch panels or surface acoustic wave panels that can identify, for example, horizontal and vertical dimensions of a touch on the touch panel. For either infra-red or surface acoustic wave panels, the number of horizontal and vertical sensors (e.g., acoustic or light sensors) detecting the touch may be used to approximate the location of a touch.

Housing 230 may protect the components of electronic device 100 from outside elements. Control buttons 240 may also be included to permit the user to interact with electronic device 100 to cause electronic device 100 to perform one or more operations, such as place a telephone call, play various media, access an application, etc. For example, control buttons 240 may include a dial button, hang up button, play button, etc. One of control buttons 240 may be a menu button that permits the user to view various settings on display 110. In one implementation, control keys 140 may be pushbuttons.

Keypad 250 may also be included to provide input to electronic device 100. Keypad 250 may include a standard telephone keypad. Keys on keypad 250 may perform multiple functions depending upon a particular application selected by the user. In one implementation, each key of keypad 250 may be, for example, a pushbutton. A user may utilize keypad 250 for entering information, such as text or a phone number, or activating a special function. Alternatively, keypad 250 may take the form of a keyboard that may facilitate the entry of alphanumeric text.

Microphone 260 may receive audible information from the user. Microphone 260 may include any component capable of transducing air pressure waves to a corresponding electrical signal. Speaker 270 may provide audible information to a user of electronic device 100. Speaker 270 may include any component capable of transducing an electrical signal to a corresponding sound wave. For example, a user may listen to music through speaker 270.

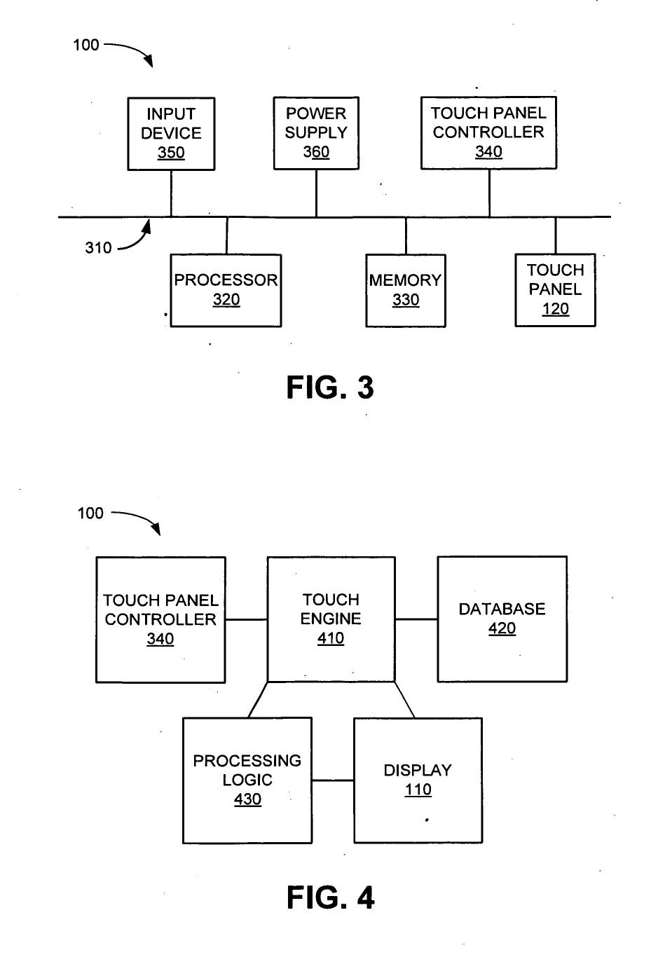

FIG. 3 is a block diagram illustrating components of electronic device 100 according to an exemplary implementation. Electronic device 100 may include bus 310, processor 320, memory 330, touch panel 120, touch panel controller 340, input device 350, and power supply 360. Electronic device 100 may be configured in a number of other ways and may include other or different components. For example, electronic device 100 may include one or more output devices, modulators, demodulators, encoders, and/or decoders for processing data.

Bus 310 may permit communication among the components of electronic device 100. Processor 320 may include a processor, a microprocessor, an application specific integrated circuit (ASIC), a field programmable gate array (FPGA), or the like. Processor 320 may execute software instructions/programs or data structures to control operation of electronic device 100.

Memory 330 may include a random access memory (RAM) or another type of dynamic storage device that may store information and instructions for execution by processor 320; a read only memory (ROM) or another type of static storage device that may store static information and instructions for use by processor 320; a flash memory (e.g., an electrically erasable programmable read only memory (EEPROM)) device for storing information and instructions; and/or some other type of magnetic or optical recording medium and its corresponding drive. Memory 330 may also be used to store temporary variables or other intermediate information during execution of instructions by processor 320. Instructions used by processor 320 may also, or alternatively, be stored in another type of computer-readable medium accessible by processor 320. A computer-readable medium may include one or more physical or logical memory devices.

Touch panel 120 may accept touches from a user that can be converted to signals used by electronic device 100. Touch coordinates on touch panel 120 may be communicated to touch panel controller 340. Data from touch panel controller 340 may eventually be passed on to processor 320 for processing to, for example, associate the touch coordinates with information displayed on display 110.

Touch panel controller 340 may include hardware- and/or software-based logic to identify input received at touch panel 120. For example, touch panel controller may identify which sensors may indicate a touch on touch panel 120 and the location of the sensors registering the touch. In one implementation, touch panel controller 340 may be included as part of processor 320.

Input device 350 may include one or more mechanisms in addition to touch panel 120 that permit a user to input information to electronic device 100, such as microphone 260, keypad 250, control buttons 240, a keyboard, a gesture-based device, an optical character recognition (OCR) based device, a joystick, a virtual keyboard, a speech-to-text engine, a mouse, a pen, voice recognition and/or biometric mechanisms, etc. In one implementation, input device 350 may also be used to activate and/or deactivate touch panel 120 or to adjust settings for touch panel 120.

Power supply 360 may include one or more batteries or another power source used to supply power to components of electronic device 100. Power supply 360 may also include control logic to control application of power from power supply 360 to one or more components of electronic device 100.

Electronic device 100 may provide a platform for a user to view images; play various media, such as music files, video files, multi-media files, and/or games; make and receive telephone calls; send and receive electronic mail and/or text messages; and execute various other applications. Electronic device 100 may perform these operations in response to processor 320 executing sequences of instructions contained in a computer-readable medium, such as memory 330. Such instructions may be read into memory 330 from another computer-readable medium. In alternative embodiments, hard-wired circuitry may be used in place of or in combination with software instructions to implement operations described herein. Thus, implementations described herein are not limited to any specific combination of hardware circuitry and software.

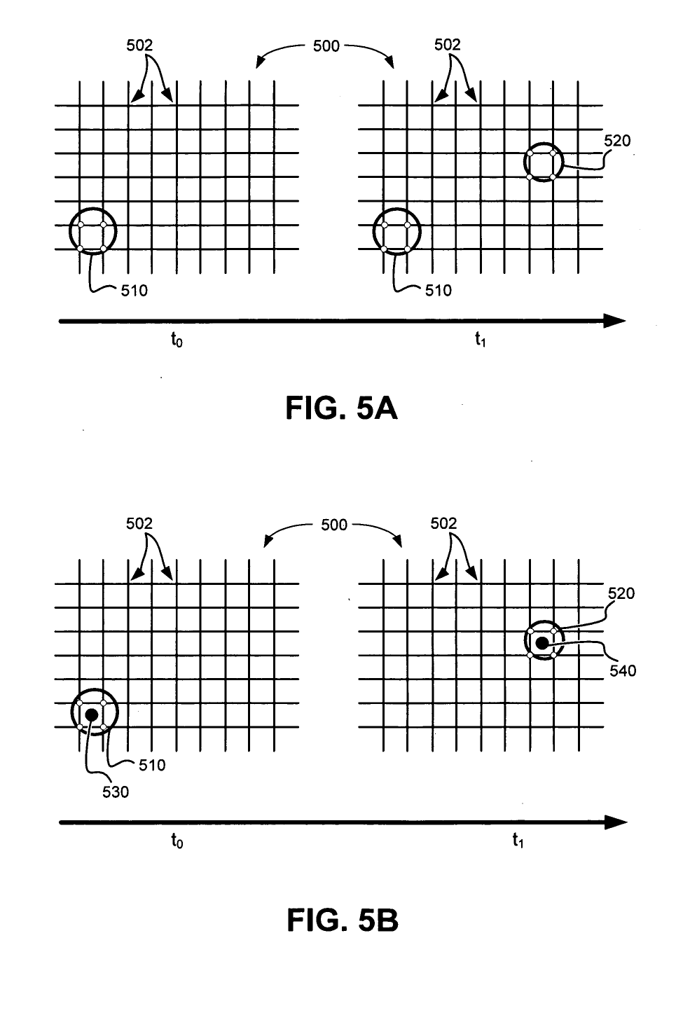

FIG. 4 is a functional block diagram of exemplary components that may be included in electronic device 100. As shown, electronic device 100 may include touch panel controller 340, touch engine 410, database 420, processing logic 430, and display 110. In other implementations, electronic device 100 may include fewer, additional, or different types of functional components than those illustrated in FIG. 4.

Touch panel controller 340 may identify touch coordinates from touch panel 120. Coordinates from touch panel controller 340, including the identity of particular sensors in, for example, the X and Y dimensions, may be passed on to touch engine 410 to associate the touch coordinates with, for example, an object displayed on display 110.

Touch engine 410 may include hardware and/or software for processing signals that are received at touch panel controller 340. More specifically, touch engine 410 may use the signal received from touch panel controller 340 to detect touches on touch panel 120 and determine sequences, locations, and/or time intervals of the touches so as to differentiate between types of touches. The touch detection, the touch intervals, the sequence, and the touch location may be used to provide a variety of user input to electronic device 100.

Database 420 may be included, for example, in memory 230 (FIG. 2) and act as an information repository for touch engine 410. For example, touch engine 410 may associate locations and/or sequences of different touches on touch panel 120 with particular touch sequences stored in database 420. In one implementation, database 420 may store time interval thresholds to identify touch command sequences. For example, a measured time interval between a first touch and a second touch may indicate that the second touch should be associated with the first touch if the measured time interval is below a stored threshold value. Also, database 420 may store lists of touch sequences that may be interpreted differently for particular applications being run on electronic device 100.

Processing logic 430 may implement changes based on signals from touch engine 410. For example, in response to signals that are received at touch panel controller 340, touch engine 410 may cause processing logic 430 to alter the magnification of an item previously displayed on display 110 at one of the touch coordinates. As another example, touch engine 410 may cause processing logic 430 to transfer a file or other information from one electronic folder location to another and to alter display 110 to represent the file transfer. As a further example, touch engine 410 may cause processing logic 430 to alter the magnification of a portion of an image or a particular section of a block of text being shown on display 110.

### Exemplary Touch Sequence Patterns

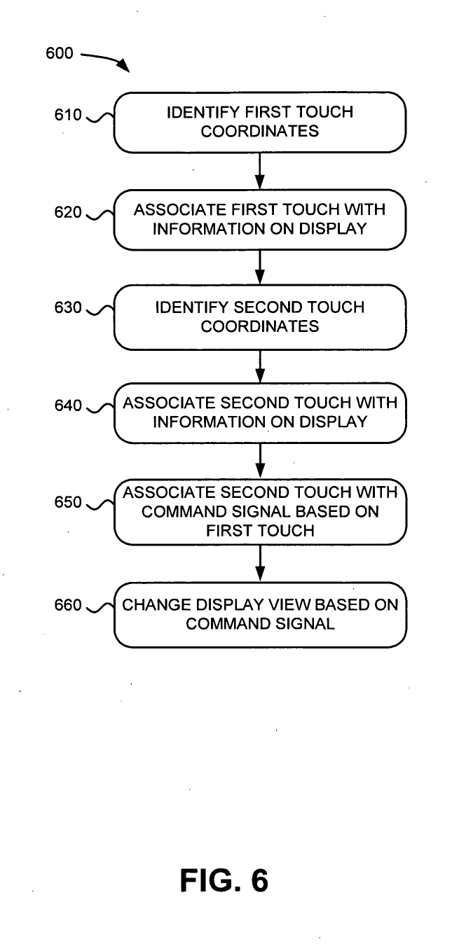

FIGS. 5A and 5B are diagrams illustrating exemplary touch sequence patterns on a surface 500 of a touch panel 120 of an exemplary electronic device. FIG. 5A is a diagram illustrating an exemplary multi-touch sequence. FIG. 5B is a diagram illustrating an exemplary single-touch sequence.

Referring collectively to FIGS. 5A and 5B, a touch panel (such as touch panel 120 of FIG. 1) may generally include a surface 500 configured to detect a touch at one or more sensing nodes 502. In one implementation, surface 500 may include sensing nodes 502 using a grid arrangement of transparent conductors to track approximate horizontal (e.g., “X”) and vertical (e.g., “Y”) positions, as shown in FIG. 5A. In other implementations, other arrangements of sensing nodes 502 may be used, including polar coordinates, parabolic coordinates, etc. The number and configuration of sensing nodes 502 may vary depending on the required accuracy/sensitivity of the touch panel. Generally, more sensing nodes can increase accuracy/sensitivity of the touch panel. A signal may be produced when an object (e.g., a user's finger) touches a region of surface 500 over a sensing node 502.

Surface 500 of FIG. 5A may represent a multi-touch sensitive panel. Each sensing node 502 may represent a different position on surface 500 of the touch panel, and each sensing node 502 may be capable of generating a signal at the same time. When an object is placed over multiple sensing nodes 502 or when the object is moved between or over multiple sensing nodes 502, multiple signals can be generated.

Referring to FIG. 5A, at time t₀, a finger (or other object) may touch surface 500 in the area denoted by circle 510 indicating the general finger position. The touch may be registered at one or more sensing nodes 502 of surface 500, allowing the touch panel to identify coordinates of the touch. In one implementation, the touch coordinates may be associated with an object on a display underlying the touch screen. In another implementation, the touch coordinates may be associated with a display separately located from surface 500. The finger may remain on touch surface 500 at position 510.

Still referring to FIG. 5A, at time t₁, another finger (or other object) may touch surface 500 in the area denoted by circle 520 indicating the general finger position. (The finger at position 510 may remain in place.) The touch at position 520 may be registered at one or more sensing nodes 502 of surface 500, allowing electronic device 100 to identify coordinates of the touch. The later time of the touch at position 520 and/or the location of the touch at position 520 may be used to indicate that the touch at position 520 may be a command input associated with the initial touch at position 510. As shown in FIG. 5A, multi-touch locations may be obtained using a touch panel that can sense a touch at multiple nodes, such as a capacitive or projected capacitive touch panel.

As shown in FIG. 5A, multi-touch touch sequences may be obtained using technologies that can generally generate signals to indicate locations and time intervals of a multi-touch sequence. Such technologies may include, for example, capacitive touch technologies.

Referring to FIG. 5B, surface 500 of FIG. 5B may represent a single-touch sensitive panel. Each sensing node 502 may represent a different position on surface 500 of the touch panel. When an object is placed over multiple sensing nodes 502, a single signal (e.g., the average of the affected sensing nodes) may be generated.

As shown in FIG. 5B, at time t₀, a finger (or other object) may touch surface 500 in the area denoted by circle 510 indicating the general finger position. The touch may be registered at one or more sensing nodes 502 of surface 500, allowing the touch panel to identify an average coordinate 530 for the touch.

At time t₁, the same or another finger (or other object) may touch surface 500 in the area denoted by circle 520 indicating the general finger position. The finger at position 510 may be removed. The touch at position 520 may be registered at one or more sensing nodes 502 of surface 500, allowing the touch panel to identify an average position 540 of the coordinates of the touch. The amount of the time interval between time t₀ and time t₁ and/or the location of the touch at position 520 may be used to indicate that the touch at position 520 may be a command input associated with the initial touch at position 510. For example, in one implementation, if the time interval between time t₀ and time t₁ is a short interval (e.g., less than a second), electronic device 110 may be instructed to associate the touch at position 520 as a command input associated with the initial touch at position 510. In another implementation, the location of the touch at position 520 may be used indicate that the touch is a command input associated with a previous touch.

As shown in FIG. 5B, single touch sequences may be obtained using technologies that can generally generate signals to indicate locations and time intervals of a touch sequence. Such technologies may include, for example, resistive technologies, surface acoustic wave technologies, infra-red technologies, or optical technologies.

### Exemplary Operations

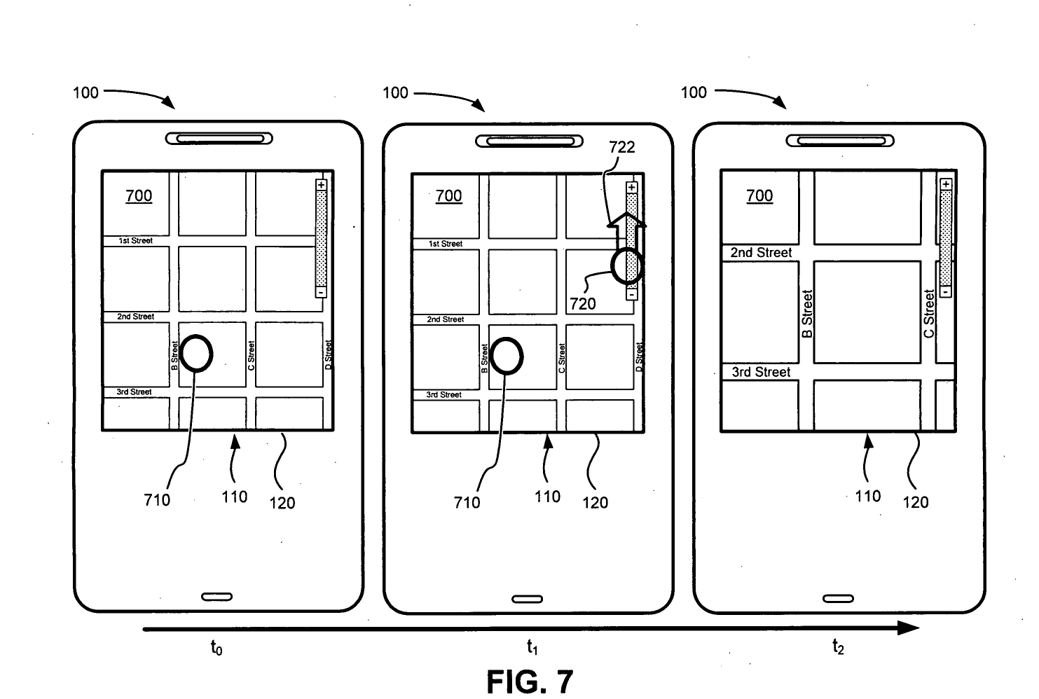

FIG. 6 is a flow diagram 600 illustrating exemplary operations associated with an electronic device having a touch panel. For example, the operations may be performed by electronic device 100 of FIG. 2, including touch panel 120 and display 110. The exemplary operations may begin with the identification of first touch coordinates (block 610). For example, electronic device 110 may identify a touch at a particular location on touch panel 120.

The first touch may be associated with information on the display (block 620). For example, electronic device 110 may associate the touch coordinates of the touch on touch panel 120 with an image or text displayed on display 110. In one implementation, the image may be, for example, a map or photograph. In another implementation, the image may be a list of files, names or titles. As will be described in more detail herein, the first touch may be associated with a particular object or a portion of an object.

Second touch coordinates may be identified (block 630). For example, electronic device 110 may identify a second touch at a particular location on touch panel 120. The second touch may occur at a later point in time than the first touch. In one implementation, the second touch may occur while the first touch is still in place. In another implementation, the second touch may occur within a particular time interval after the first touch is removed.

The second touch may be associated with information on the display (block 640). For example, electronic device 110 may associate the touch coordinates of the second touch on touch panel 120 with an image or text displayed on display 110. In one implementation, the image associated with the second touch may be the same image or text (e.g., a different location on the same image or text block) previously associated with the first touch. In another implementation, the image associated with the second touch may be a scroll bar or other command bar related to the object associated with the first touch.

The second touch coordinates may be associated with a command signal based on the first touch (block 650). For example, electronic device 100 may associate the second touch with a command signal based on an attribute of the first touch, such as the location of the first touch and/or the time of the first touch in relation the second touch. For example, in one implementation, the location of the first touch on a portion of a displayed image along with a relatively short interval (e.g., a fraction of a second) before the second touch on the same image may indicate a zoom command. In another implementation, the location of the first touch on a portion of a displayed image and maintaining the touch while the second touch is applied on the same image may indicate a zoom command being centered at the location of the first touch.

The display view may be changed based on the command signal (block 660). For example, electronic device 100 may perform the command action to alter the view of information on display 110. In one implementation, the command action may be a zoom action to alter the magnification of an image, such as a map or photograph. The magnification of the image may be centered, for example, at the point of the image associated with the first touch in block 620. In another implementation, the command action may be a file management command for a playlist. A playlist may be identified, for example, by the first touch, so that the second touch on a selected file may be interpreted as a command action to move the selected file to the playlist. In still another implementation, the command action may be a partial enlargement or distortion of a text presented on the display. For example, electronic device 100 may enlarge a portion of text near the location of the second touch based on the location of the first touch and time interval from the first touch.

### Exemplary Implementations

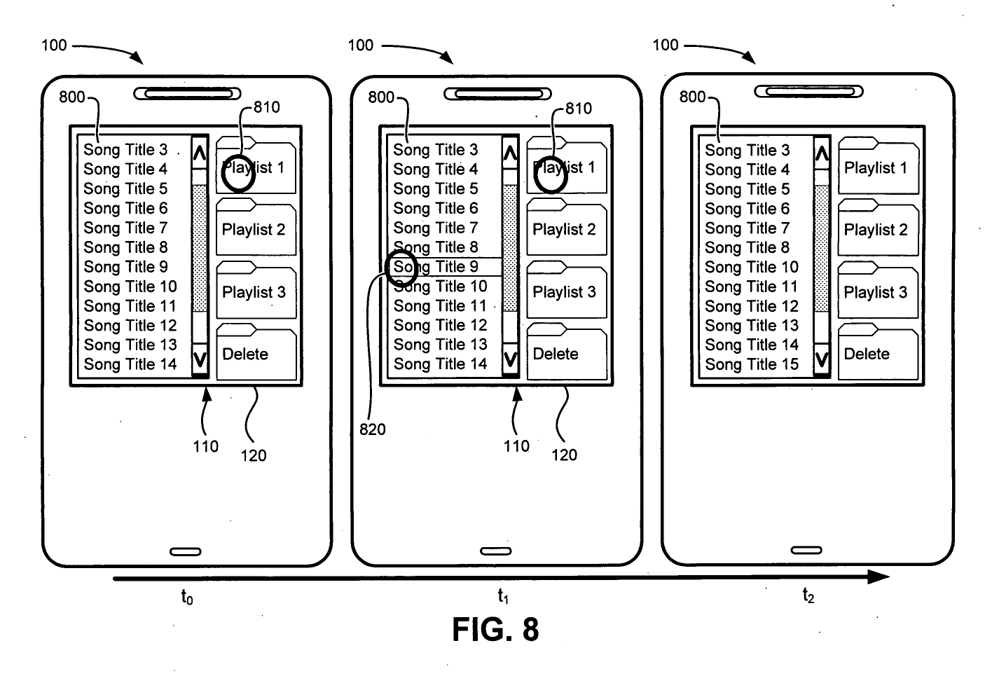

FIG. 7 shows an exemplary touch input on the surface of a display as a function of time according to an exemplary implementation. As shown in FIG. 7, electronic device 100 may show on display 110 a map image 700. Electronic device 100 may include a touch panel 120 to receive user input. At time t₀, a user may touch a particular location 710 on touch panel 120 that corresponds to a location on image 700 on display 110. The particular location 710 may correspond to, for example, an area of interest to a user.

At time t₁, a user may touch a second location 720 on touch panel 120. In the implementation shown in FIG. 7, the second touch location 720 may be on a magnification scroll bar. However, in other implementations, no scroll bar may be visible. At time t₁, the touch at the first location 710 may still be applied, while the touch at the second location 720 may be added. The touch at the second location 720 may be interpreted as a command. Particularly, the touch at the second location 720 may be interpreted by electronic device 100 as a zoom command to increase or decrease the magnification of image 700 using location 710 as the center point of the magnified image. In one implementation, the touch at the second location 720 may be followed by a dragging motion 722 to indicate a degree of magnification (e.g., an upward motion may indicate an magnification command with the level of magnification increasing with the length of dragging motion 722). In another implementation, the touch at the second location 720 may be a single touch at, for example, a particular point on a magnification scroll bar that corresponds to a particular magnification level.

At time t₂, the image 700 may be shown on display 110 as magnified and centered within display 110 at a location corresponding to the touch at the first location 710 at time t₀. A typical zoom command may require a command to identify the location of a zoom and then a separate command to perform the zoom function. The implementation described herein allows electronic device 100 to receive a dual-input (e.g., location of zoom and zoom magnification) as a single operation from a user to perform a zoom command.

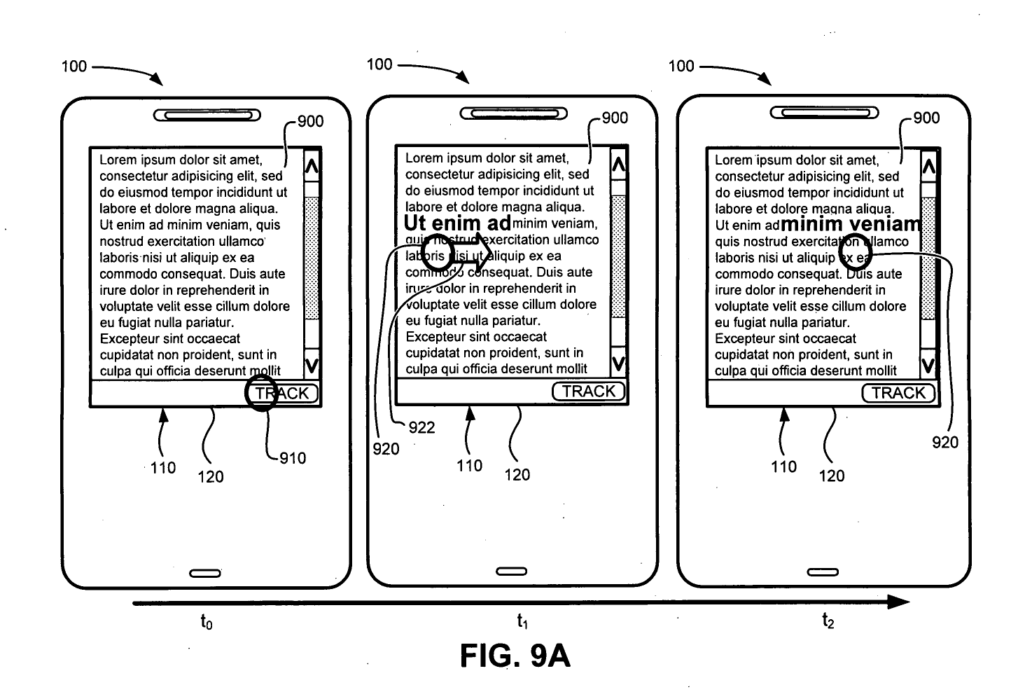

FIG. 8 shows an exemplary touch input on the surface of a display as a function of time according to another exemplary implementation. As shown in FIG. 8, electronic device 100 may show on display 110 a file list 800 with folders (e.g., “Playlist 1,” “Playlist 2,” “Playlist 3,” and “Delete”). Electronic device 100 may also include a touch panel 120 to receive user input. At time t₀, a user may touch a particular location 810 on touch panel 120 that corresponds to a location on display 110. The particular location 810 may correspond to, for example, a folder of interest to a user, such as “Playlist 1.”

At time t₁, a user may touch a second location 820 on touch panel 120. In the implementation shown in FIG. 8, the second touch location 820 may be on a selection of a particular file name (e.g., “Song Title 9”). In other implementations, the order of the first touch location 810 and the second touch location 820 may be reversed. At time t₁, the touch at the first location 810 may still be applied, while the touch at the second location 820 may be added. In another implementation, the touch at the second location 820 may be applied within a particular time interval of the touch at the first location 810. The touch at the second location 820 may be interpreted as a command. Particularly, the touch at the second location 820 may be interpreted by electronic device 100 as a file transfer command to copy or move the selected file (e.g., “Song Title 9”) from file list 800 to the folder “Playlist 1” at the first touch location 810.

In one implementation, the touch at the second location 820 may be followed by subsequent touches (not shown) to indicate selection of other files that may be copied/moved to the “Playlist 1” folder. For example, as long as the touch at the first touch location 810 remains in contact with touch panel 120, a user may complete subsequent selections from file list 800 to move to the “Playlist 1” folder. The order of the selection of the files from file list 800 to the “Playlist 1” may determine the sequence of the files in the “Playlist 1” folder.

At time t₂, the display list 800 may be shown on display 110 as having “Song Title 9” removed from the file list 800. In other implementations (e.g., when the command is interpreted as a “copy” command) the file name may remain in file list 800, even though the file has been added to the selected play list. While the example of FIG. 8 is discussed in the context of a playlist for a music application, list manipulation using the systems and methods described herein may also apply to other types of lists, such as locations for a route in a map application.

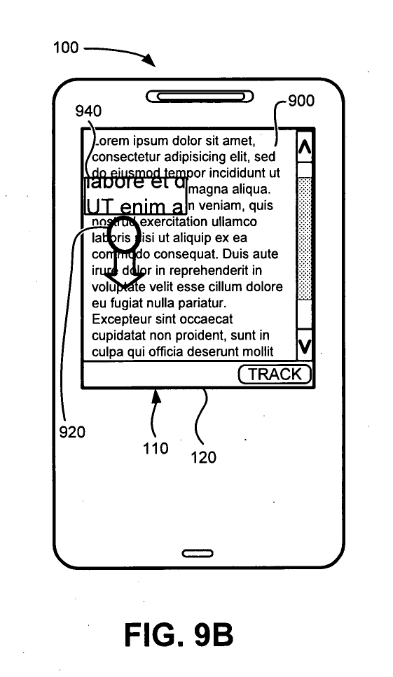

FIG. 9A shows an exemplary touch input on the surface of a display as a function of time according to a further exemplary implementation. As shown in FIG. 9A, electronic device 100 may show a text block 900 on display 110. Text block 900 may be, for example, text from a hypertext markup language (html) file, a simple text (txt) file, an email, an SMS message, a hyperlink, a web page, or any other type of electronic document. Electronic device 100 may also include a touch panel 120 to receive user input. At time t₀, a user may touch a particular location 910 on touch panel 120 that corresponds to a location on display 110. The particular location 910 may correspond to, for example, a “Track” command button, as shown in FIG. 9A. In another implementation, the particular location may not correspond to a command button, but instead may be located anywhere on text block 900.

At time t₁, a user may touch a second location 920 on touch panel 120. In the implementation shown in FIG. 9A, the second touch location 920 may be slightly below a portion of text of interest to a user. In one implementation, prior to time t₁, the touch at the first location 910 may be removed (e.g., where the first touch has triggered the “Track” command button). In another implementation, the touch at the first location 910 may still be applied at time t₁, while the touch at the second location 920 may be added. In still another implementation, the touch at the second location 920 may be applied within a particular time interval of the touch at the first location 910 that indicates triggering of a tracking function. The touch at the second location 920 may be interpreted by electronic device 100 as a command to enlarge the display of text in the vicinity of the touch at the second location 920. Particularly, the touch at the second location 920 may be interpreted as a magnification command for the area directly above the touch at the second location 920.

In one implementation, the touch at the second location 920 may be followed by a dragging motion 922 that, for example, generally follows along the sequence of the displayed text. Thus, the touch at the second location 920 may continue to track and enlarge the particular text being indicated by the user. In one implementation, as shown in FIG. 9A, the text in the vicinity of the touch at the second location 920 may be enlarged by temporarily increasing the default font size of the text. Thus, subsequent text in the text box may, thus be re-formatted to adjust to the larger text. At time t₂, the text block 900 may be shown on display 110 with the second touch location having been moved slightly to the right to location 920. The text above location 920 at time t₂ is thus enlarged accordingly.

In another implementation, as shown in FIG. 9B, the text in the vicinity of the touch at the second location 920 may be presented as a magnifying window, such as window 940. Window 940 may move along with the touch at the second location 920, thus enlarging other information on display 110. In another implementation, the location of second touch 920 in text block 900 may be used to indicate a users location of interest in text block 900. Thus, electronic device 100 can identify when a user has encountered the end of the viewable portion of text block 900 on display 110 and scroll the text accordingly.

The tracking function may allow a user to display a file (such as a web page) on display 110 at a size and/or resolution sufficient to provide the user with an overall presentation of the intended formatting while enabling a user to view particular portions of the display with increased magnification. Furthermore, electronic device 100 may scroll the viewable portion of text from a file based on the user's touch without the need for a text cursor or other device.

### Exemplary Device

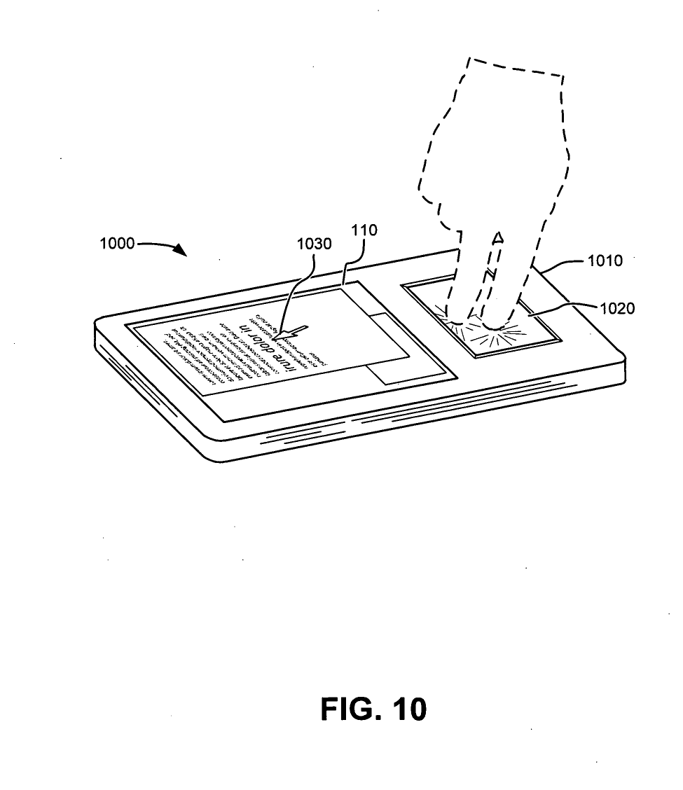

FIG. 10 is a diagram of another exemplary electronic device 1000 in which methods and systems described herein may be implemented. Electronic device 1000 may include housing 1010, display 110, and touch pad 1020. Other components, such as control buttons, a keypad, a microphone, a camera, connectivity ports, memory slots, and/or additional speakers, may be located on electronic device 1000, including, for example, on a rear or side panel of housing 1010. FIG. 10 illustrates touch panel 1020 being separately located from display 110 on housing 1010. Touch panel 1020 may include any multi-touch touch panel technology or any single-touch touch panel technology providing the ability to measure time intervals between touches as the touch panel 1020 registers a set of touch coordinates. User input on touch panel 1020 may be associated with display 110 by, for example, movement and location of cursor 1030. User input on touch panel 1020 may be consistent with the underlying touch panel technology (e.g., capacitive, resistive, etc.) so that a touch of nearly any object, such as a body part (e.g., a finger, as shown), a pointing device (e.g., a stylus, pen, etc.), or a combination of devices may be used.

Touch panel 1020 may be operatively connected with display 110. For example, touch panel 1020 may include a multi-touch near field-sensitive (e.g., capacitive) touch panel that allows display 110 to be used as an input device. Touch panel 1020 may include the ability to identify movement of an object as it moves on the surface of touch panel 1020. As described above with respect to, for example, FIG. 9A, a first touch followed by a second touch may be identified as a command action. In the implementation of FIG. 10, the multiple touch may correspond to a tracking command for the text on display 110 (e.g., to enlarge the text above cursor 1030), where the first touch may indicate a cursor 1030 location and a second touch (within a particular time interval) may initiate tracking from the location of the cursor 1030.

### Conclusion

Implementations described herein may include a touch-sensitive interface for an electronic device that that can recognize a first touch input and a second touch input to provide user input. The first touch input may identify an object or location on a display, while the second touch input may provide a command action associated with the object or location identified by the first touch. The command action may be, for example, a zoom command or a file manipulation command associated with information displayed at the location of the first touch.

The foregoing description of the embodiments described herein provides illustration and description, but is not intended to be exhaustive or to limit the invention to the precise form disclosed. Modifications and variations are possible in light of the above teachings or may be acquired from practice of the invention.

For example, implementations have been mainly described in the context of a mobile communication device. These implementations, however, may be used with any type of device with a touch-sensitive display that includes the ability to distinguish between locations and/or time intervals of a first and second touch.

As another example, implementations have been described with respect to certain touch panel technology. Other technology that can distinguish between locations and/or time intervals of touches may be used to accomplish certain implementations, such as different types of touch panel technologies, including but not limited to, surface acoustic wave technology, capacitive touch panels, infra-red touch panels, strain gauge mounted panels, optical imaging touch screen technology, dispersive signal technology, acoustic pulse recognition, and/or total internal reflection technologies. Furthermore, in some implementations, multiple types of touch panel technology may be used within a single device.

Further, while a series of blocks has been described with respect to FIG. 6, the order of the blocks may be varied in other implementations. Moreover, non-dependent blocks may be performed in parallel.

Aspects described herein may be implemented in methods and/or computer program products. Accordingly, aspects may be embodied in hardware and/or in software (including firmware, resident software, micro-code, etc.). Furthermore, aspects described herein may take the form of a computer program product on a computer-usable or computer-readable storage medium having computer-usable or computer-readable program code embodied in the medium for use by or in connection with an instruction execution system. The actual software code or specialized control hardware used to implement these aspects is not limiting. Thus, the operation and behavior of the aspects were described without reference to the specific software code—it being understood that software and control hardware could be designed to implement the aspects based on the description herein.

Further, certain aspects described herein may be implemented as “logic” that performs one or more functions. This logic may include firmware, hardware—such as a processor, microprocessor, an application specific integrated circuit or a field programmable gate array—or a combination of hardware and software.

It should be emphasized that the term “comprises/comprising” when used in this specification is taken to specify the presence of stated features, integers, steps, or components, but does not preclude the presence or addition of one or more other features, integers, steps, components, or groups thereof.

Even though particular combinations of features are recited in the claims and/or disclosed in the specification, these combinations are not intended to limit the invention. In fact, many of these features may be combined in ways not specifically recited in the claims and/or disclosed in the specification.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on,” as used herein is intended to mean “based, at least in part, on” unless explicitly stated otherwise.

What is claimed is:

1. A method performed by a device having a touch panel and a display, the method comprising:
identifying touch coordinates of a first touch on the touch panel;
associating the first touch coordinates with an object on the display;
identifying touch coordinates of a second touch on the touch panel;
associating the second touch coordinates with an object on the display;
associating the second touch with a command signal based on the coordinates of the first touch and the second touch; and
altering the display based on the command signal.

2. The method of claim 1, where the first touch is maintained during the second touch.

3. The method of claim 1, where the first touch is removed prior to the second touch, and where the method further comprises:
determining a time interval between the first touch and the second touch; and
comparing the time interval with a stored value that indicates the first touch is associated with the second touch.

4. The method of claim 1, where the object is an image and where the command action comprises:
altering the magnification of the image on the display using the touch coordinates of the first touch as the centering point for the altering of the magnification.

5. The method of claim 1, where the object is a text sequence and where the command action comprises:
altering the magnification of a portion of the text sequence on the display using the touch coordinates of the second touch to identify the portion of the text where the altering of the magnification is implemented.

6. The method of claim 5, where the second touch is dragged along the touch panel and where altering the magnification of a portion of the text sequence includes altering the magnification of the portion of the text above the changing coordinates of the dragged second touch.

7. The method of claim 1, where the object is a file list and where the command action comprises:
copying a file selected with the second touch to a file list selected with the first touch.

8. A device comprising:
a display to display information;
a touch panel to identify coordinates of a first touch and coordinates of a second touch on the touch panel;
processing logic to associate the first touch coordinates with a portion of the information on the display;
processing logic to associate the second touch coordinates with another portion of the information on the display;
processing logic to associate the second touch with a command signal based on the portion of the information on the display associated with the first touch coordinates and the other portion of the information on the display associated with the second touch coordinates; and
processing logic to alter the display based on the command signal.

9. The device of claim 8, where the touch panel comprises a capacitive touch panel.

10. The device of claim 8, where the processing logic alters the magnification of the information on the display using the touch coordinates of the first touch as the centering point for the altering of the magnification.

11. The device of claim 8, where the processing logic alters the magnification of a portion of the information on the display based on the touch coordinates of the second touch that identify the portion of the information where the altering of the magnification is to be implemented.

12. The device of claim 11, where the information on the display is text and where altering the magnification comprises changing the font size of the text.

13. The device of claim 11, where the information on the display in the vicinity of the second touch coordinates is presented in a magnifying window.

14. The device of claim 8, where the portion of information associated with the first touch coordinates is a file list and the portion of information associated with the second touch coordinates is a file selected by a user, and where the command signal comprises a signal to copy the file selected by the user to the file list.

15. The device of claim 8, where the touch panel is overlaid on the display.

16. The device of claim 8, further comprising:
a housing, where the touch panel and the display are located on separate portions of the housing.

17. The device of claim 8, further comprising:
a memory to store a list of touch sequences that may be interpreted differently for particular applications being run on the device, where the processing logic to associate the second touch with a command signal is further based on the list of touch sequences.

18. A device comprising:
means for identifying touch coordinates of a first touch and a second touch on a touch panel, where the first touch precedes the second touch and the first touch is maintained during the second touch;
means for associating the first touch coordinates with information on the display;
means for associating the second touch coordinates with information on the display;
means for associating the second touch with a command signal based on the information associated with the first touch and the second touch; and
means for altering the display based on the command signal.

19. The device of claim 18, where the means for altering the display based on the command signal comprises means for altering the magnification of information on the display using the touch coordinates of the first touch as the centering point for the altering of the magnification.

20. The device of claim 18, where the means for altering the display based on the command signal comprises means for altering the magnification of a portion of information on the display using the touch coordinates of the second touch to identify the portion where the altering of the magnification is implemented.
